(19) United States
(12) Patent Application Publication
(10) Pub. No.: US 2006/0054199 A1
(43) Pub. Date: Mar. 16, 2006

(54) Sump assembly of dishwasher

(75) Inventors: Sang Heon Yoon, Seoul (KR); Nung Seo Park, Incheon (KR); Byung Hwan Ahn, Changwon-si (KR); Dae Yeong Han, Seoul (KR)

Correspondence Address: MCKENNA LONG & ALDRIDGE LLP, 1900 K STREET, NW, WASHINGTON, DC, 20006, US

(73) Assignee: LG Electronics Inc., Seoul (KR)

(21) Appl. No.: 11/059,642

(22) Filed: Feb. 17, 2005

(30) Foreign Application Priority Data
Sep. 14, 2004 (KR) P2004-73397

(51) Int. Cl. B08B 3/00

(52) U.S. Cl. 134/56 D; 134/58 D

(57) ABSTRACT

The present invention provides a sump assembly of a dishwasher, in which water is stored to be supplied to spray nozzles. The sump assembly comprises a sump housing storing water therein, a pump coupled with the sump housing to pump the water, and a heater assembly coupled with the sump housing to heat the water. The heater assembly is detachable from the sump housing at an outside of the sump housing.

This application claims the benefit of the Korean Application No. P2004-073397 filed on Sep. 14, 2004, which is hereby incorporated by reference.

### BACKGROUND OF THE INVENTION

1. Field of the Invention

The present invention relates to a dishwasher, and more particularly, to a sump assembly of a dishwasher, in which water is stored to be supplied to spray nozzles.

2. Discussion of the Related Art

Generally, a dishwasher is a home appliance for washing tableware by spraying water of high pressure on the tableware using spray nozzles. A general dishwasher consists of a tub having a washing chamber inside, a plurality of dish racks provided within the tub, a plurality of spray nozzles spraying water on the dish racks, and a sump assembly storing the water therein and supplying the water to the spray nozzles.

In operating the dishwasher, clean water supplied from outside is stored in the sump assembly and the sump assembly supplies the water stored inside to the spray nozzles. The spray nozzles then spray the water on dishes put on the dish racks within the tub to wash them.

However, the general dishwasher washes the dishes by spraying the water of high pressure on the dishes only, which has difficulty in removing adhesive food from the dishes completely.

### SUMMARY OF THE INVENTION

Accordingly, the present invention is directed to a sump assembly of a dishwasher that substantially obviates one or more problems due to limitations and disadvantages of the related art.

An object of the present invention is to provide a sump assembly of a dishwasher, by which adhesive food can be completely removed from a dish using hot water for washing the dish.

Another object of the present invention is to provide a sump assembly of a dishwasher, by which water can be supplied to a spray arm without a heat loss of the water heated by a heater.

Another object of the present invention is to provide a sump assembly of a dishwasher, by which a heater for heating water is facilitated to be detachably assembled to a sump housing.

A further object of the present invention is to provide a sump assembly of a dishwasher, by which water leakage from a connecting portion between a heater and a sump housing can be effectively prevented.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a sump assembly of a dishwasher according to the present invention includes a sump housing storing water therein, a pump coupled with the sump housing to pump the water, and a heater assembly coupled with the sump housing to heat the water and detachable from the sump housing at an outside of the sump housing.

The heater assembly is situated at a bottom of the sump housing. Preferably, the sump housing comprises a recess provided at a bottom of the sump housing to store the water therein and the heater assembly is situated at the recess.

The sump housing comprises an opening provided to a lateral side of the sump housing to be penetrated by the heater assembly.

The heater assembly comprises a heat generating part situated within the sump housing to heat the water; and a terminal passing through the opening and projected to the outside of the sump housing.

The heat generating part is configured to prevent the heater from interfering with parts within the sump housing when the heater assembly is inserted in the sump housing through the opening or is pulled out from the sump housing.

The heater assembly further comprises a clamp fixed to the sump housing to hold and support the heater. Preferably, the heat generating part slides to be fitted in the clamp in inserting the heater assembly in the sump housing or to be released from the clamp in withdrawing the heater assembly, through the opening.

The heater assembly comprises a heater penetrating the opening to heat the water; and a packing fitted in the opening to seal the opening and to be penetrated by the heater.

The heater assembly further comprises a pressurizing mechanism completely sealing the opening by pressing the packing to transform.

Preferably, the packing has a thickness greater than a depth of the opening.

The pressurizing mechanism is configured to expand a lateral side of the packing to prevent the packing from escaping from the opening.

The pressurizing mechanism comprises a first member contacted with the packing, a second member contacted with the packing and supported by an outer surface of the sump housing, and a third member connected to the first and second members and tightened to make the first and second members get close each other in order to pressurize the packing.

Preferably, the third member can be tightened or loosened from outside of the sump housing.

The third member comprises a bolt extended from the first member and penetrating the packing to be projected from the sump housing externally, and a nut locked to the bolt to pressurize the packing so that the packing laterally expands.

Preferably, the first member and the packing are configured to have a size substantially equal to or smaller than the opening further wherein the heater assembly can be withdrawn outside the sump housing through the opening when the third member is loosen.

The sump housing further comprises a recessed seat provided on the outer surface of the sump housing to receive an edge of the second member thereon.

In another aspect of the present invention, a dishwasher includes a tub receiving tableware therein, a sump housing storing water therein, a pump coupled with the sump housing to pump the water, a heater assembly coupled with the sump housing to heat the water and detachable from the sump housing at an outside of the sump housing, and at least one spray nozzle washing the tableware by spraying the pumped water on the tableware received in the tub.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a cross-sectional diagram of a dishwasher according to the present invention;

FIG. 2 is an exploded diagram of a sump assembly according to the present invention;

FIG. 3 is an exploded diagram of a heater assembled to a sump housing in the sump assembly in FIG. 2;

FIG. 4A is a partial cross-sectional diagram of a fixing mechanism before a pressurizing mechanism pressurizing a packing in a heater assembly in FIG. 3;

FIG. 4B is a partial cross-sectional diagram of a fixing mechanism after a pressurizing mechanism pressurizing a packing in a heater assembly in FIG. 3; and

FIG. 5 is a cross-sectional diagram of one end of a heater fixed to a sump housing by a clamp.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

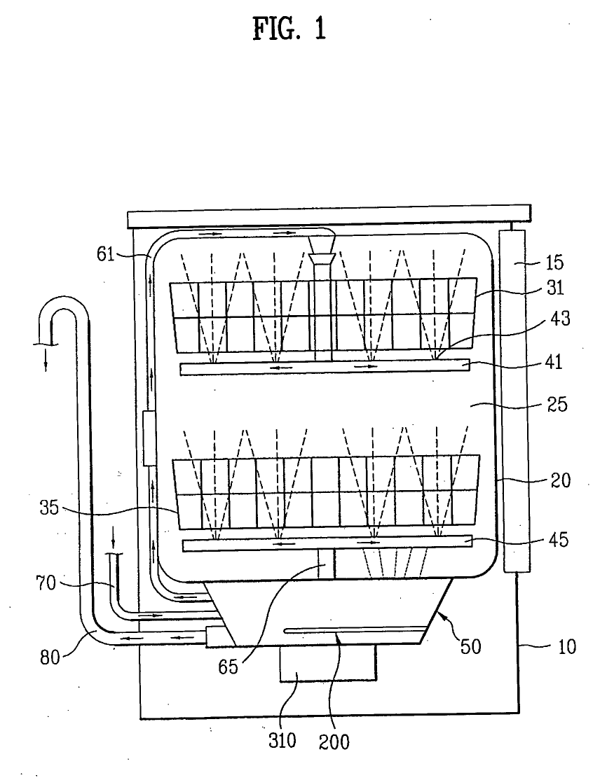

FIG. 1 is a cross-sectional diagram of a dishwasher according to the present invention.

Referring to FIG. 1, a tub 20 is provided within a case 10 forming an exterior of a dishwasher, and a door 15 opening/closing the tub 20 is provided to one side of the case 10. A washing chamber 25 for accommodating tableware or dishes therein is provided within the tub 20. And, at least one rack is provided to the washing chamber 25 so that the dishes can be put thereon. For instance, the rack, as shown in FIG. 1, includes an upper rack 31 provided to an upper part of the washing chamber 25 and a lower rack 35 provided to a lower part of the washing chamber 25.

Moreover, at least one spray arm is provided in the vicinity of the rack within the washing chamber 25. For instance, the spray arm, as shown in FIG. 1, includes an upper arm 41 arranged under the upper rack 31 and a lower arm 45 arranged under the lower rack 35. The upper and lower arms 41 and 45 are respectively rotatable, and each of the upper and lower arms 41 and 45 includes at least one spray nozzle 43 spraying water toward the dishes.

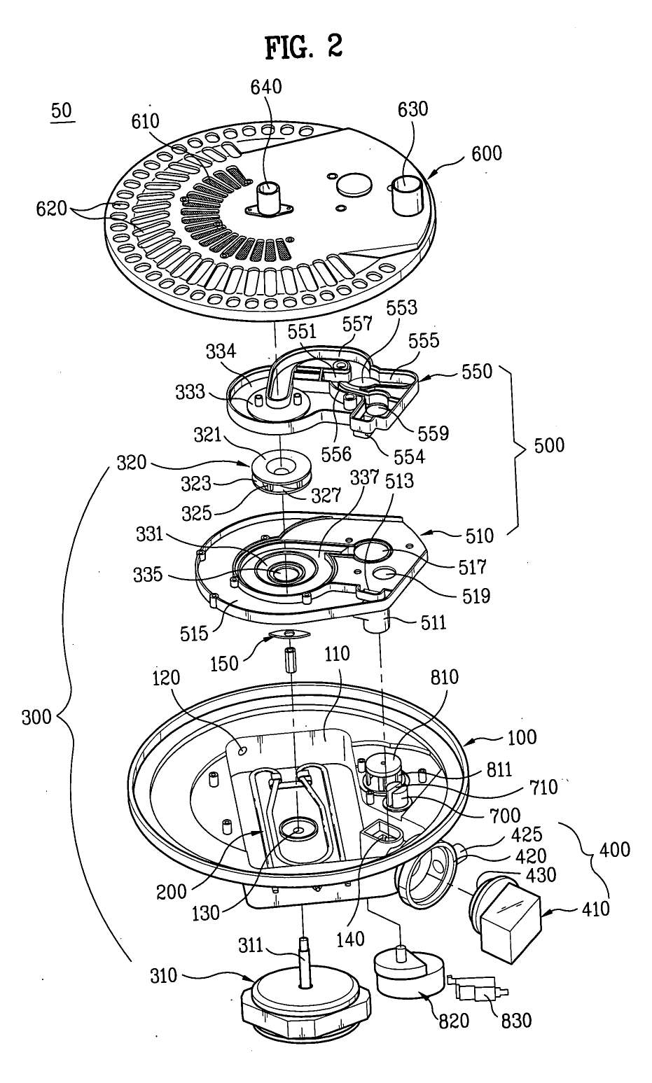

A sump assembly 50 supplying water to the upper and lower arms 41 and 45 is provided within the case 10, e.g., under the tub 20. The sump assembly 50 is connected to the upper arm 41 via a first connecting pipe 61 and is connected to the lower arm 45 via a second connecting pipe 65. And, the sump assembly 50 is supplied with the water from outside via a water supply pipe 70 to store the supplied water therein and selectively or simultaneously supply the water to the upper and lower arms 41 and 45 via the first and second connecting pipes 61 and 65, respectively. A detailed configuration of the sump assembly 50 is shown in FIG. 2, and the sump assembly is explained in detail with reference to FIG. 2 as follows.

Referring to FIG. 2, the sump assembly 50 includes a sump housing 100 storing water therein, a heater assembly 200 for heating the water, a drain pump 400 for draining the water outside, a water supply pump 300 for pumping the water stored in the sump housing 100, a water guide assembly 500 for supplying the pumped water to the upper and lower arms 41 and 45, and a cover 600 covering the sump housing 100 to filter the water.

A recess 110 is provided to a bottom center of the sump housing 100 to store the water, and a water supply hole 120 is provided to one side of the recess 100 to be connected to the water supply pipe 70. And, a drain chamber 140 is provided to the sump housing 100 in the vicinity of the recess 110. The drain chamber 140 includes a hole (not shown in the drawing) provided to a lateral side of the drain chamber 140 to communicate with the recess 110 and an open top communicating with a soil chamber 515 provided to the water guide assembly 500.

The drain pump 400 is loaded in a lateral side of the sump housing 100. The drain pump 400 communicates with the drain chamber 140 and discharges the water within the recess 110, the drain chamber 140, and the soil chamber 515 outside. And, the drain pump 400 includes an impeller housing 420, a motor 410, and an impeller 430.

The impeller housing 420, as shown in FIG. 2, is coupled to a lateral side of the sump housing 100 and communicates with the drain chamber 140. The impeller housing 420 can be built in one body of the sump housing 100. A nipple 425 is projected from a lateral side of the impeller housing 420 to be connected to a drain hose 80.

The motor 410 having a shaft, with which the impeller 430 is coupled, is assembled to the impeller housing 420 so that the impeller 430 can be inserted in the impeller housing 420. Hence, once the drain pump 400 is actuated, the water stored in the recess 110, the drain chamber 140, and the soil chamber 515 is discharged outside via the drain chamber 140, the drain pump 400, and the drain hose 80.

The water supply pump 300 pumps the water above the heater assembly 200 to supply the water heated by the heater assembly 200 to the spray arms without heat loss. The water supply pump 300 includes a motor 310, an impeller 320, and an impeller housing, which is explained in detail as follows.

First of all, the motor 310, as shown in FIG. 2, is installed at a bottom of the sump housing 100. A shaft 311 of the motor 310 is installed to penetrate a hole 130 provided to a bottom of the recess 110. A disposer 150 having a multitude of blades, as shown in FIG. 2, is assembled to the shaft 311 penetrating the bottom of the sump housing 100. If the motor 310 is actuated, the disposer 150 is rotated to dispose garbage that is contained in the water stored in the recess 110.

The impeller 320 is assembled to the shaft 311 as well. The impeller 320, as shown in FIG. 2, is situated over the heater assembly 200 and is rotated to pump the water heated by the heater assembly 200. The impeller 320 is explained in detail as follows.

First of all, the impeller 320 sucks the water in an axial direction and discharges the water in a radial direction. For this, the impeller 320 includes an upper plate 321, a lower plate separated from the upper plate 323 to leave a predetermined gap from each other, and a multitude of blades 325 provided between the upper and lower plates 321 and 323.

The upper plate 321 is blocked and an inlet (not shown in the drawing) is provided to a center of the lower plate 323 to have the water flow therein. A hub (not shown in the drawing) is provided to a center of the upper plate 321 and the shaft 311 is fitted in a lower end of the tub. A multitude of curved blades 325 are provided between the upper and lower plates 321 and 323, and an outlet 327 is provided between the blades 325 to discharge the water having flown in the impeller 320 via the inlet.

The impeller housing encloses the impeller 320 to guide the water moved by the impeller 320. The impeller housing is preferably built in one body of the water guide assembly 500 instead of being formed of an independent body. In this case, the water guide assembly 500 includes a lower piece 510 and an upper piece 550. If the upper and lower pieces 550 are assembled, a portion of the assembly configures the impeller housing. The impeller housing is explained in detail as follows.

First of all, to a top surface of the lower piece 510 of the water guide assembly 500, as shown in FIG. 2, provided are an inlet 335 via which the water stored in the recess 110 of the sump housing 100 flows, a lower recessed seat 331 accommodating a lower part of the impeller 320 therein, and a lower water passage 337 guiding the water pumped by the impeller 337. The lower recessed seat 331 is provided to enclose the inlet 335, and the inlet 335 communicating with the inlet (not shown in the drawing) of the impeller 320 situated on the lower recessed seat 331. And, the lower water passage 337 is provided to enclose the lower recessed seat 331.

To a bottom surface of the upper piece 50 of the water guide assembly 500 provided are an upper recessed seat 333 accommodating an upper part of the impeller 320 to confront the lower recessed seat 331, an upper water passage 334 guiding the water pumped by the impeller 320 to confront the lower water passage 337, and an outlet 551 guiding the water pumped from the upper water passage 334 to an upper surface of the upper piece 550. The upper water passage 334 is provided to enclose the upper recessed seat 333 and the output 551 is formed at an end of the upper water passage 334.

Once the motor 310 is actuated, the impeller 320 is rotated in a space defined by the lower and upper recessed seats 331 and 333. The water stored in the recess 110 of the sump housing 100 flows in the impeller 320 via the inlet 335 and the impeller 320 discharges the water in a radial direction. The water discharged from the impeller 320 moves along the water passage defined by the lower and upper water passages 337 and 334 and is finally led to the top surface of the upper piece 550 of the water guide assembly 500 via the outlet 551. A portion of the water having flown to the top surface of the upper piece 550 is selectively guided to the upper or lower arm 41 or 45 or is simultaneously guided to the upper and lower arms 41 and 45. The water guide assembly 500 is explained in detail as follows.

First of all, the water guide assembly 500 includes the upper and lower pieces 550 and 510. The upper piece 550 is provided with a valve receiving portion 553 communicating with the outlet 551. And, first and second guide passages 557 and 555 for supplying the water to the lower and upper arms 45 and 41 are connected to the valve receiving portion 553, respectively. In this case, the first guide passage 557 is provided to the top surface of the upper piece 550 from the valve receiving portion 553 to a center of the upper piece 550, while the second guide passage 555 is provided to the top surface of the upper piece 550 from the valve receiving portion 553 to an edge of the upper piece 550.

A diverting valve 810 is situated at the valve receiving portion 553 to guide a portion of the water flowing from the outlet 551 to the first or second guide passages 557 or 555 selectively or to the first and second guide passages 557 and 555 simultaneously.

To a lateral side of the diverting valve 810 provided are a multitude of passages via which the first and second guide passages 557 and 555 communicate with each other and a rib 811 enabling the first or second guide passage 57 or 555 to be selectively blocked.

The diverting valve 810, as shown in FIG. 2, is loaded in the sump housing 100 and becomes situated at the valve receiving portion 553 when the water guide assembly 500 is assembled to the sump housing 100. For this, a hole 517 is formed at the lower piece 510 to correspond to the valve receiving portion 553 so that the diverting valve 810 and to be penetrated by the hole 517.

A driving mechanism for actuating the diverting valve 810 is provided under the sump housing 100. The driving mechanism, as shown in FIG. 2, includes a crank 820 connected to the diverting valve 810, a linkage 830 connected to the crank 820, and a power source, e.g., a step motor (not shown in the drawing), connected to the linkage 830. The linkage makes a rectilinear reciprocation by the step motor, whereas the crank 820 converts the rectilinear reciprocation to a rotational motion of the diverting valve 810.

Hence, when the dishwasher washes or rinses the dishes, the diverting valve 810 is reversibly rotated by the driving mechanism. In doing so, the rib 811 selectively blocks the first and second guide passage 557 or 555. Thus, the water pumped by the water supply pump 300 is supplied to the first or second guide passages 557 or 555 selectively or to the first and second guide passages 557 and 555 simultaneously. The water led to the first and second guide passages 557 and 555 is supplied to the upper and lower arms 45 and 41, respectively.

Meanwhile, after having been pumped by the water supply pump 300, the rest of the water guided to the top surface of the upper piece 550 of the water guide assembly is used in measuring a degree of pollution of the water, is filtered, and then goes back to the sump housing 100 to be stored in the recess 110, which is explained in detail as follows.

First of all, a bypass 556 communicating with the outlet 551 is provided to the top surface of the upper piece 550. A sensor receiving portion 559 is provided in the middle of the bypass 556. A sensor assembly 700 is situated in the sensor receiving portion 559 to measure a degree of pollution of the water that flows in the bypass 556 by being pumped by the water supply pump 300.

The sensor assembly 700, as shown in FIG. 2, is loaded in the sump housing 100 to be located at the sensor receiving portion 559 when the water guide assembly 500 is loaded on the sump housing 100. For this, a hole 519 is provided to the lower piece 510 to correspond to the sensor receiving portion 559 and to be penetrated by the sensor assembly 700.

A channel 710 communicating with the bypass 556, as shown in FIG. 2, is provided to traverse a center of the sensor assembly 700. Hence, the water flowing in the bypass 556 passes through the channel 710. A light emitting unit (not shown in the drawing) and a light receiving unit (not shown in the drawing) are provided within the sensor assembly 700 to oppose each other by leaving the channel 710 in-between. A light emitted from the light emitting unit is passed through the water flowing in the channel 710 to arrive at the light receiving unit. Hence, the sensor assembly 700 measures the degree of pollution of the water based on the intensity of the light received by the light receiving unit.

The water pollution degree measured by the sensor assembly 700 is used as a basis for determining a washing time, a washing number, a rinsing time, a rinsing number, and the like. For instance, if a quantity of light arriving at the light receiving unit is very weak, it means that the water is badly polluted. In such a case, the dishwasher changes the water or extends the washing or rinsing number by at least one time.

Meanwhile, the water having passed through the sensor assembly 700 reaches a first drain 554 provided to an end of the bypass 556. The first drain 554 is connected to a second drain 513 provided to the lower piece 510, and extends to the drain chamber 140 of the sump housing 100 from the lower piece 510. Hence, the rest of the water, which is introduced into the top surface of the upper piece 550 after having been pumped by the water supply pump 300, is passed through the bypass 556, the sensor assembly 700, and the first and second drains 554 and 513 to flow in the drain chamber 140.

The water in the drain chamber 140 is not discharged outside via the drain hose 80 unless the drain pump is actuated 400. As a check valve (not shown in the drawing) opening/closing the hole (not shown in the drawing), via which the drain chamber 140 and the recess 110 communicate with each other, is provided to the drain chamber 140, the water in the drain chamber 140 is not introduced into the recess 110 as well.

Hence, the water introduced into the drain chamber 140 ascends along a third drain 511 via which the drain chamber 140 and the soil chamber 515 of the lower piece 510 to flow in the soil chamber 515. In ding so, heavy garbage included in the water introduced into the drain chamber 140 is deposited at a bottom of the drain chamber 140 due to its weight but the light garbage and water are introduced into the soil chamber 515. Hence, the drain chamber 140 makes the garbage deposited to filter the water.

The soil chamber 515, as shown in FIG. 2, is provided to the lower piece 510 to enclose the impeller housing of the water supply pump 300. The soil chamber 515 receives to store the water passed through the bypass 556 and the drain chamber 140 after the water have been pumped by the water supply pump 300. If the water keeps flowing in the soil chamber 515, a water level of the soil chamber 515 rises and the water finally floods out of the soil chamber 515.

Meanwhile, the cover 600 covers the water guide assembly 500 and the sump housing 100. For instance, the cover 600 has a disc shape. A multitude of openings are provided to its central part. And, a mesh type filter 610, as shown in FIG. 2, is provided to each of the openings. In this case, the openings and the filters 610 are arranged over the soil chamber 515. Hence, the water flooding from the soil chamber 515 passes through the filter 610 to be filtered and the dirt or garbage failing to pass through the filter 610 remains in the soil chamber 515.

A multitude of apertures 620 are provided to an edge area of the cover 600. The apertures 620 guide the falling water used in washing the dishes in the tub 20 of the dishwasher and the flooding water passed through the filter 610 from the soil chamber 515 to the sump housing 100. The water guided to the sump housing 100 is stored in the recess 110 at the center of the sump housing 100 together.

A first nipple 640 at a center of the cover 600 and a second nipple 630 at an edge of the cover 600, as shown in FIG. 2, are provided to a top surface of the cover 600. The first nipple 640 communicates with the first guide passage 557 of the water guide assembly 500 and the second nipple communicates with the second guide passages 555 of the water guide assembly 500. The second connecting pipe 65 connected to the lower arm 45 is connected to the first nipple 640, and the first connecting pipe 61 connected to the upper arm 41 is connected to the second nipple 630. Hence, the water introduced into the first guide passage 557 is supplied to the lower arm 45 via the first nipple 640 and the second connecting pipe 65. And, the water introduced into the second guide passage 555 is supplied to the lower arm 45 via the second nipple 630 and the first connecting pipe 61.

Meanwhile, the dishwasher according to the present invention can completely remove the adhesive food attached to the dishes using hot water. For this, the heater assembly 200 is provided within the sump housing 100 to heat the water stored in the recess 110. The heater assembly 200 is detachably provided to the sump housing 100 so as to be externally detached from the sump housing 100. The heater assembly 200 is explained in detail with reference to FIGS. 2 to 5 as follows.

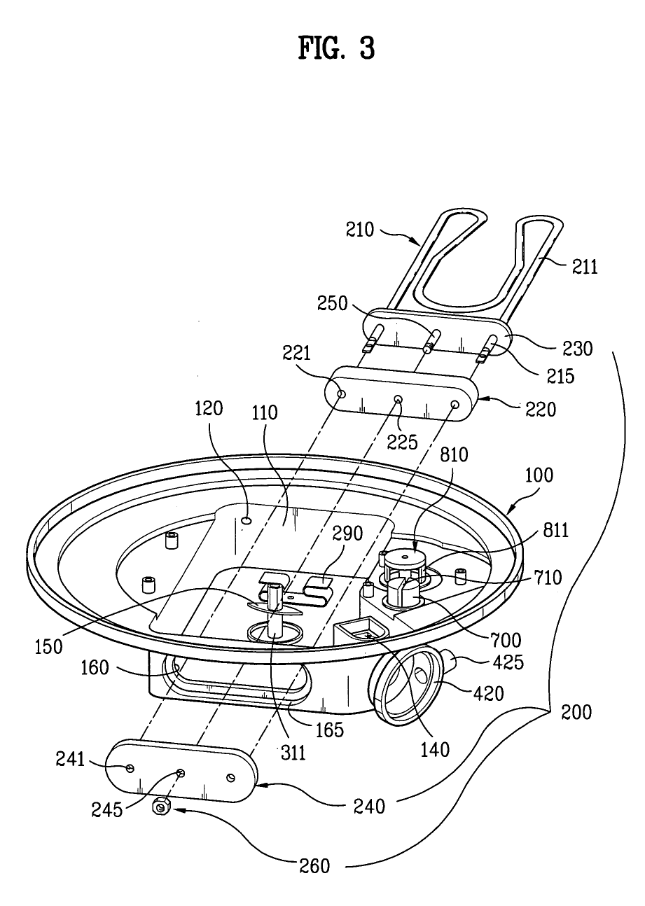

First of all, the heater assembly 200 is situated at a bottom of the sump housing, e.g., a bottom of the recess 110. An opening 160, as shown in FIG. 3, is provided to a lateral side of the sump housing 100, and the heater assembly 200 is installed to penetrate the opening 160. And, the heater assembly 200 includes a heater 210 heating water and a fixing mechanism fixing the heater 210 to the sump housing 100 to enable the heater 210 to be detachable from the sump housing 100 at an outside of the sump housing 100 without disassembly of the sump assembly 50.

The heater 210 includes a heat generating part 211 situated within the sump assembly 50, and more particularly, within the recess 110 to heat the water and terminals 215 connected to the heat generating part 211. The heat generating part 211 is bent several times to cover a considerable area of the recess 110, and the terminals 215 penetrate the opening 160 to be externally projected from the sump housing 100.

In spite of being bent several times, the heat generating part 211 of the heater 210 does not interfere with parts within the sump housing 100 when the heater assembly 200 is inserted in the sump housing 100 through the opening 160 or is pulled out of the sump housing 100. Namely, even if the shaft 311 of the water supply pump 300 runs through the sump housing 100, the heat generating part 211 is bent to enclose the shaft 311 and the disposer 150 with a ‘U’ shape. Hence, the heat generating part 211 avoids interfering with the shaft 311 and the disposer 15 when the heater assembly 200 is pulled out of the sump housing 100.

One side of the heater 210 is fixed to the sump housing 100 by the fixing mechanism, which is explained in detail as follows. The packing 220 is fitted in the opening 160 and the terminals 215 of the heater 210 are installed to penetrate the packing 220 though holes 221, respectively. The packing 220 seals the opening 160 to prevent the water from leaking through the opening 160. Only with such a basic structure, the heater 210 can be stably loaded in the sump housing 100. And, the heater assembly 200 can be separated from the sump assembly 50 by being pulled out from outside of the sump housing 100.

Optionally, the present invention further provides a pressuring mechanism to raise a sealing power of the packing 220 and to fix the heater 210 thereto more stably. The pressurizing mechanism presses the packing 220 provided to the opening 160 so that the packing 220 is transformed. Hence, the transformed packing 220 can completely prevent the water from leaking through the opening 160. Moreover, the pressurizing mechanism prevents the packing 220 from escaping from the opening 160 when the heater assembly 200 is completely coupled with the sump housing 100. Such a pressurizing mechanism is explained in detail as follows.

First of all, the pressurizing mechanism includes first and second members 230 and 240 opposing each other by leaving the packing 220 in-between and a third member connected to the first and second members 230 and 240. The third member is tightened or loosened to change a reciprocal distance between the first and second members 230 and 240 to pressurize or depressurize the packing 220.

The first member 230 is situated in the sump housing 100, is connected to the heater 210, and is contacted with one face of the packing 220. In this case, the first member 230 has a size substantially equal to or smaller than the opening 160. And, the packing 220 has a size enough to be inserted in the opening 160 as well. Hence, an assembly including the heater 210, the first member 230, and the packing 220 can be inserted in the recess 110 of the sump housing 100 through the opening 160 from outside of the sump housing 100.

The second member 240 is situated outside of the sump housing 100. An edge of the second member 240 is supported by an outer surface of the sump housing 100. And, the second member 240 comes into contact with the other face of the packing 220. Moreover, the second member 240 has a size bigger than that of the opening 160 to cover the opening 160. Hence, when the heater assembly 200 is completely loaded in the sump housing 100, the heater assembly 200 is unable to further enter the sump housing 100 via the opening 160 due to the second member 240.

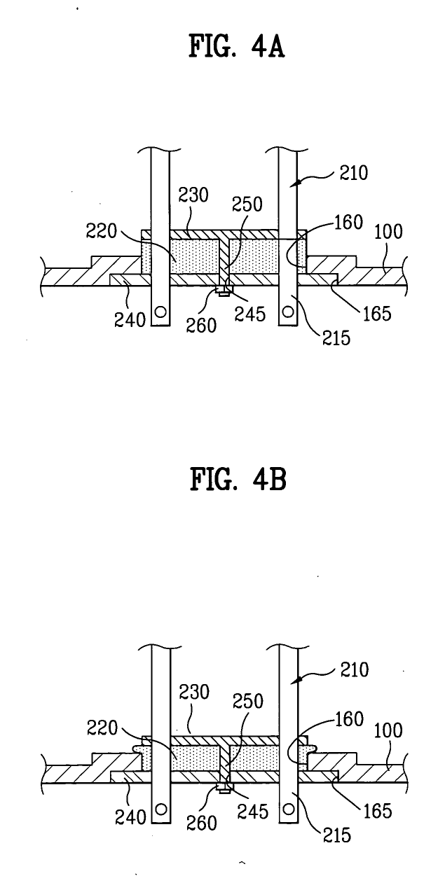

Meanwhile, a recessed seat 165, as shown in FIG. 4A or FIG. 4B, is provided to an outer surface of the sump housing to receive an edge of the second member 240 thereon. Hence, when the heater assembly 200 is loaded in the sump housing 100, a surface of the second member 240 is not projected from the outer surface of the sump housing 100.

And, the third member can be tightened or loosened from outside of the sump housing. For instance, the third member includes a bolt 250 and a nut 260. The bolt 250 extends from the first member 230, penetrates the packing and second member 220 and 240 via the holes 225 and 245 of the packing 220 and second member 220 and 240, respectively, and is then projected from the sump housing externally. And, the nut 260 is locked to the bolt 250 from outside of the sump housing 100. Hence, if the nut 260 is tightened from the outside of the sump housing 100, the first member 230 gets closer to the second member 240 to pressurize the packing 220. On the other hand, if the nut 260 is loosened from the outside of the sump housing 100, the first member 230 gets farther from the second member 240 to depressurize the packing 220.

In assembling the above-configured heater assembly 200, an assembly of the heater 210 and the first member 230, as shown in FIG. 4A, is preferentially inserted in the sump housing 100 via the opening 160. The packing 220 is then fitted in the opening 160. If so, the terminals 215 of the heater 210 and the bolt 250 of the third member penetrate the packing 220 to be externally exposed from the sump housing 100. Once the packing 220 is fitted in the opening 160, the nut 260, as shown in FIG. 4A, is locked to the bold 250.

Until the pressurizing mechanism, as shown in FIG. 4A, pressurizes the packing 220, the heater assembly 220 fails to be completely fixed to the sump housing 100. Namely, since each size of the packing 220 and the first member 230 substantially becomes equal to or smaller than that of the opening 160, the heater assembly 200 is separated from the sump assembly 50 in case of pulling the heater assembly 200 out of the sump housing 100.

Yet, if the nut 260, as shown in FIG. 4B, is tightened, the packing 220 is pressurized by the first and second members 230 and 240 so that the packing 220 laterally expands. Since a thickness of the packing 220 is greater than a depth of the opening 160, a lateral potion, as shown in FIG. 4B, of the packing 220 failing to be contacted with an inside of the opening 160 among a lateral side of the packing 220 laterally expands. Thus, the laterally expanding portion of the packing 220 pressed by the pressurizing mechanism is caught on an inside of the sump housing 100, whereby the heater assembly 200 is unable to externally escape from the sump housing 100 via the opening 160.

As explained in the aforesaid description, the heater assembly 200 is stably fixed to the sump housing 100 if the third member is tightened or is facilitated to be externally separated from the sump housing 100 if the third member is loosened. Hence, in case that the heater assembly 200 is out of order or that the heater 210 needs to be replaced, the heater assembly 200 can be easily replaced without disassembling the sump assembly 50.

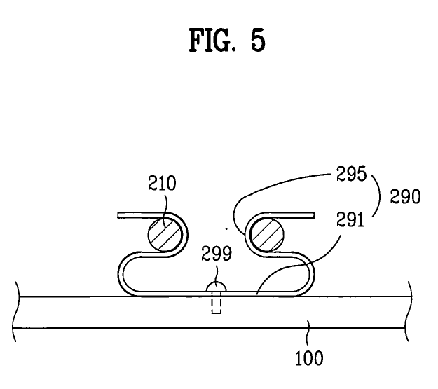

Meanwhile, one end of the heater 210 is fixed to the sump housing 100 by the fixing mechanism, whereas the other end 210 of the heater 210, as shown in FIG. 3 and FIG. 5, is held and supported by a clamp 290 provided to the bottom of the sump housing 100. The clamp 290 is fixed to the bottom of the recess 110 and holds the heat generating part 211 to prevent the heat generating part 211 from being fluctuated by a flow of the water.

The clamp 290 has at least one or more curved portions 295, and the heat generating part 211 of the heater 210 is inserted in the at least one or more curved portions 295 to be tightly supported. Specifically, a pair of the curved portions 295 are provided to confront each other and are connected to each other by a connecting portion 291, for example. And, the connecting portion 291, as shown in FIG. 5, is fixed to the recess 110 by a locking member such as a screw 299 and the like.

A pair of the curved portions 295 respectively hold to support the heat generating part 211. When the heater assembly 200 is inserted in the sump housing 100 via the opening 160, the heat generating part 211 slides to be fitted in the curved portions of the clamp 290 to be fixed thereto. On the other hand, when the heater assembly 200 is withdrawn outside the sump housing 100 via the opening 160, the heat generating part 211 slide to be released from the curved portions 295. Thus, despite holding to support the other end of the heater 210, the clamp 290 avoids interrupting the movement of the heater 210 in case of loading/unloading the heater assembly 200 in/from the sump housing via the opening 160. Therefore, the heater assembly 200 can be externally loaded/unloaded in/from the sump housing 100.

An operation of the above-configured sump assembly according to the present invention is explained as follows. First of all, if the dishwasher initiates a process of washing or rinsing dishes, clean water is introduced into the recess 110 of the sump housing 100 via the water supply hole 120. The water introduced into the recess 110 is then heated by the heater 210. If a corresponding water supply is completed, the motor 310 of the water supply pump 300 is driven so that the impeller 320 pumps the water stored in the recess 110.

A portion of the pumped water flows in the valve receiving portion 553 via the outlet 551 and is then led to the first or second guide passage 557 or 555 by the diverting valve 810. The water led to the first guide passage 557 is supplied to the lower arm 45, while the other water led to the second guide passage 555 is supplied to the upper arm 41. The water supplied to the lower arm 45 washes the dishes put on the lower rack 35 and the water supplied the upper arm 41 washes the dishes put on the upper rack 31.

The water used in washing the dishes in the tub 20 and the garbage or soil detached from the dishes fall down to the bottom of the tub 20. The falling garbage and water are re-introduced into the sump housing 100 via the apertures 620 provided to a circumference of the cover 600 to be re-stored in the recess 110. As mentioned in the foregoing description, the water fed back to the sump housing 110 contains a considerable amount of dirt or garbage. The garbage is finely grinded by the disposer 150 situated between the impeller 320 and the bottom of the recess 110 of the sump housing 100. And, the finely grinded garbage is pumped by the pump together with the water.

Meanwhile, the rest of the water pumped by the impeller 320 of the pump is introduced into the bypass 556. The water introduced into the bypass 556 passes through the channel 710 of the sensor assembly 700 that accurately measures the pollution degree of the water flowing in the channel 710. Hence, the dishwasher automatically adjusts the washing time, the washing number, the rinsing time, the rinsing number, etc. based on the pollution degree of the water sensed by the sensor assembly 700.

The water having passed through the channel 710 of the sensor assembly 700 is introduced into the drain chamber 140 via the first and second drains 554 and 513. In doing so, since the drain pump 400 is not working, the water in the drain chamber 140 is not discharged outside but flown in the soil chamber 515 via the third drain 511. In ding so, heavy garbage included in the water introduced into the drain chamber 140 is deposited at a bottom of the drain chamber 140 due to its weight but the light garbage ascends along the third drain 511 to be introduced into the soil chamber 515.

The garbage and water introduced into the soil chamber 515 are stored therein. As time passes, the water level of the soil chamber 515 rises and the water finally floods out of the soil chamber 515. The flooding water is passed through the filter 610 and the apertures 620 of the sump housing 100 in turn to be re-introduced into the sump housing 100. Yet, the garbage introduced into the soil chamber 515 fails to pass through the filter 610 to be accumulated within the soil chamber 515.

As mentioned in the foregoing description, a prescribed quantity of the pumped water is passed through the bypass 556 to be purified by the filter 610 and is then re-supplied to the sump housing 100. In doing so, it may seem that the soil chamber 515 and the filter 610 filter a small quantity of the water only. Yet, since they filter the water across the washing and rinsing cycles overall, excellent water-filtering performance is achieved.

Meanwhile, if the washing or rinsing cycle is completed or if the water is badly polluted, the drain pump 400 is actuated. If so, the water and garbage stored in the soil chamber 515, the drain chamber 140, and the recess 110 of the sump housing 100 are discharged outside by the drain pump 400 via the drain hose 80.

Accordingly, the present invention can completely remove the adhesive food attached to the dishes by spraying the hot water heated by the heater assembly on the dishes.

And, the heater assembly is loaded in the sump housing by the unique fixing and pressurizing mechanisms according to the present invention. Hence, the present invention facilitates to load/unload the heater assembly in/from the sump assembly from outside of the sump assembly without disassembly of the sump assembly.

Moreover, the present invention completely prevents the water from leaking from the connecting part between the sump housing and the heater assembly.

It will be apparent to those skilled in the art that various modifications and variations can be made in the present invention. Thus, it is intended that the present invention covers the modifications and variations of this invention provided they come within the scope of the appended claims and their equivalents.

1. A sump assembly of a dishwasher, comprising:
a sump housing storing water therein;
a pump coupled with the sump housing to pump the water; and
a heater assembly coupled with the sump housing to heat the water, and detachable from the sump housing at an outside of the sump housing.

2. The sump assembly of claim 1, wherein the heater assembly is situated at a bottom of the sump housing.

3. The sump assembly of claim 1, wherein the sump housing comprises a recess provided at a bottom of the sump housing to store the water therein and further wherein the heater assembly is situated at the recess.

4. The sump assembly of claim 1, wherein the sump housing comprises an opening provided to a lateral side of the sump housing to be penetrated by the heater assembly.

5. The sump assembly of claim 4, wherein the heater assembly comprises
a heat generating part situated within the sump housing to heat the water; and
a terminal passing through the opening and projected to the outside of the sump housing.

6. The sump assembly of claim 5, wherein the heat generating part is configured to prevent the heater from interfering with parts within the sump housing when the heater assembly is inserted in the sump housing through the opening or is pulled out from the sump housing.

7. The sump assembly of claim 5, wherein the heater assembly further comprises a clamp fixed to the sump housing to hold and support the heater.

8. The sump assembly of claim 7, wherein the heat generating part slides to be fitted in the clamp in inserting the heater assembly in the sump housing or to be released from the clamp in withdrawing the heater assembly, through the opening.

9. The sump assembly of claim 4, wherein the heater assembly comprises
a heater penetrating the opening to heat the water; and
a packing fitted in the opening to seal the opening and to be penetrated by the heater.

10. The sump assembly of claim 4, wherein the heater assembly comprises
a heater penetrating the opening to heat the water;
a packing provided to the opening to be penetrated by the heater; and
a pressurizing mechanism completely sealing the opening by pressing the packing to transform.

11. The sump assembly of claim 10, wherein the packing has a thickness greater than a depth of the opening.

12. The sump assembly of claim 10, wherein the pressurizing mechanism is configured to expand a lateral side of the packing to prevent the packing from escaping from the opening.

13. The sump assembly of claim 10, wherein the pressurizing mechanism comprises
a first member contacted with the packing;
a second member contacted with the packing and supported by an outer surface of the sump housing; and
a third member connected to the first and second members and tightened to make the first and second members get close each other in order to pressurize the packing.

14. The sump assembly of claim 13, wherein the third member can be tightened or loosened from outside of the sump housing.

15. The sump assembly of claim 13, wherein the third member comprises
a bolt extended from the first member and penetrating the packing to be projected from the sump housing externally; and
a nut locked to the bolt to pressurize the packing so that the packing laterally expands.

16. The sump assembly of claim 13, wherein the first member and the packing are configured to have a size substantially equal to or smaller than the opening further wherein the heater assembly can be withdrawn outside the sump housing through the opening when the third member is loosen.

17. The sump assembly of claim 13, wherein the sump housing further comprises a recessed seat provided on the outer surface of the sump housing to receive an edge of the second member thereon.

18. The sump assembly of claim 4, the heater assembly comprises
a heater penetrating the opening to heat the water;
a packing provided to the opening to be penetrated by the heater;
a first member provided in the sump housing and contacted with the packing;
a second member contacted with the packing and having a edge supported by an outer surface of the sump housing;
a bolt penetrating the packing and the second member to be projected from the sump housing externally; and
a nut locked to the bolt to pressurize the packing.

19. A dishwasher comprising:
a tub receiving tableware therein;
a sump housing storing water therein;
a pump coupled with the sump housing to pump the water;
a heater assembly coupled with the sump housing to heat the water, and detachable from the sump housing at an outside of the sump housing; and
at least one spray nozzle washing the tableware by spraying the pumped water on the tableware received in the tub.

20. The dishwasher of claim 19, wherein the heater assembly comprises a heater configured to be prevented from interfering with parts within the sump housing when the heater assembly is detached from the sump housing.

21. The dishwasher of claim 19, wherein the heater assembly comprises
a heater heating the water; and
a clamp fixed to the sump housing, holding and supporting the heater, wherein the heater slides to be fitted in the clamp in inserting the heater assembly in the sump housing or to be released from the clamp in withdrawing the heater assembly.

22. The dishwasher of claim 19, further comprising
an opening provided to a lateral side of the sump housing; a heater penetrating the opening to heat the water;
a packing provided in the opening to be penetrated by the heater; and
a pressurizing mechanism completely sealing the opening by pressing the packing to transform.

23. The dishwasher of claim 22, wherein the packing is configured to have a thickness greater than a depth of the opening.

24. The dishwasher of claim 22, wherein the pressurizing mechanism is configured to expand a lateral side of the packing to prevent the packing from coming out from the opening.

25. The dishwasher of claim 22, wherein the pressurizing mechanism comprises
a first member contacted with the packing;
a second member contacted with the packing and supported by an outer surface of the sump housing; and
a third member connected to the first and second members and tightened to make the first and second members get close each other in order to pressurize the packing.

26. The dishwasher of claim 25, wherein the third member can be tightened or loosened from outside of the sump housing.

27. The dishwasher of claim 25, wherein the third member comprises
a bolt extended from the first member and penetrating the packing to be projected from the sump housing externally; and
a nut locked to the bolt to pressurize the packing so that the packing laterally expands.

28. The dishwasher of claim 25, wherein the first member and the packing are configured to have a size substantially equal to or smaller than the opening further wherein the heater assembly can be withdrawn outside the sump housing through the opening when the third member is loosen.

29. The dishwasher of claim 25, wherein the sump housing further comprises a recessed seat provided on the outer surface of the sump housing to receive an edge of the second member thereon.
